(19) United States
(12) Patent Application Publication
(10) Pub. No.: US 2020/0067136 A1
(43) Pub. Date: Feb. 27, 2020

(54) BLOCK POLYMER ELECTROLYTE FOR LITHIUM ION BATTERIES

(71) Applicants: Robert Bosch Battery Systems, LLC, Orion, MI (US); Robert Bosch GmbH, Stuttgart (DE)

(72) Inventor: David Naughton, Oxford, MI (US)

(21) Appl. No.: 16/106,980

(22) Filed: Aug. 21, 2018

(51) Int. Cl. H01M 10/0565; H01M 10/0585; H01M 10/0525; C08F 297/02

(52) U.S. Cl. CPC H01M 10/0565; H01M 10/0585; H01M 10/0525; H01M 2300/0091; H01M 2300/0082; H01M 2300/0068; C08F 297/02

(57) ABSTRACT

An electrolyte material for a solid-state lithium-ion battery includes a linear block copolymer that includes a first polymer block covalently bonded to a second polymer. The first polymer block is an ionically-conductive atactic poly(propylene oxide) block that is combined with a salt to provide an ionically-conductive domain configured to provide pathways for ion conduction through the electrolyte material. The second polymer block is a structural polymer block configured to provide a structural domain for the electrolyte material.

### BACKGROUND

The present disclosure relates to solid state batteries, such as lithium-ion batteries, and more particularly to electrolytes for use in such batteries.

The demand for safe and economical energy storage devices with high energy densities and fast charge/discharge rates is ever-growing. Electrochemical devices, such as rechargeable batteries and fuel cells, have provided promising solutions in form of clean and sustainable energy storage systems. Lithium batteries are ideal for rechargeable batteries due to several desirable features, including high energy densities, low self-discharge rates, high open circuit potentials, and minimal memory effects. Typically, a rechargeable lithium battery is composed of several electrochemical cells to provide the required voltage and capacity. Each cell consists of two electrodes, anode and cathode, and an electrolyte system.

Depending on the anode materials and electrolyte systems, the lithium batteries can be divided into several different categories. Lithium ion batteries, which typically use an anode material such as graphite, tin, or silicon to host the lithium ion, are the most common. Lithium ions travel through an electrolyte between two intercalation compounds, such as carbonaceous material (anode) and lithium cobalt oxide (cathode). The electrolyte system usually requires a separator membrane and a gel-like (or liquid-like) ion-conducting medium that provides mechanical integrity and ion conducting properties, respectively. Typically, lithium ion batteries can achieve conductivities on the order of 10⁻² S/cm at room temperature, a 300-500 charge/discharge cycle life, and an electrochemical stability window within the 0-4 V range. A carefully selected electrolyte system is necessary to avoid thermal runaway reactions and dendrite formation during repeated charge-discharge cycles.

Since the first rechargeable lithium battery (lithium ion battery) was commercialized by Sony Corporation in 1991, significant efforts have focused on improving the battery's life cycle and safety. One prevalent approach is to reduce the amount of organic solvent in the electrolyte system. Though organic solvents offer improved ion transport compared to a dry (solvent-free) electrolyte system, solvent usage renders the system thermally and electrochemically unstable. To reduce solvent usage while maintaining the ionic conductivity, lithium polymer batteries using gel-type polymer electrolytes were commercialized. This less-volatile polymer electrolyte system allows the batteries to be fabricated in various configurations and has been used in devices including cellular telephones and laptop computers. However, inappropriate operation of lithium polymer batteries still may cause delamination of cell materials, leading to reduced battery life, cell expansion, or even fires. These safety concerns have promoted interest in solid-state lithium batteries with a solvent-free composition.

Lithium batteries with solid electrolytes function as follows. During charging, a voltage applied between the electrodes of a battery causes lithium ions and electrons to be withdrawn from lithium hosts at the battery's positive electrode. Lithium ions flowing from the positive electrode to the battery's negative electrode through a polymer electrolyte are reduced at the negative electrode. During discharge, the opposite reaction occurs. Lithium ions and electrons are allowed to re-enter lithium hosts at the positive electrode as lithium is oxidized at the negative electrode. This energetically favorable, spontaneous process converts chemically stored energy into electrical power that an external device can use.

Solid-state lithium batteries use either a dry polymer electrolyte system (e.g., poly(ethylene oxide) (PEO)) or a metal-oxide electrolyte system (e.g., lithium lanthanum titanium oxide or lithium phosphate). These solvent-free electrolytes are thermally and electrochemically stable compared to the traditional liquid or gel-like electrolyte systems and provide sufficient ionic conductivities (>10⁻⁴ S/cm at 50° C.). The stability of solvent-free electrolytes has opened the possibility of using, lithium metal as anode material to provide much higher energy density than previous anode materials. However, when lithium metal serves as anode, the possibility of dendrite formation is increased by non-uniform electrochemical deposition of lithium during subsequent charging. To inhibit the growth of dendrites, electrolytes with high elastic moduli are suggested, on the order of 7 GPa or greater.

Although metal-oxide electrolyte systems typically exhibit higher elastic moduli than dry polymer electrolyte systems, metal-oxide electrolyte systems usually are limited to thin film lithium battery applications due to material processability considerations. Considering the mass production of large battery systems, dry polymer electrolyte systems are more adaptable to continuous processing than metal-oxide electrolyte systems and can be implemented easily in commercial battery cell designs at low fabrication cost. However, the current dry polymer electrolytes tend to suffer from either insufficient ionic conductivities or subpar mechanical strength.

To improve the mechanical strength of the polymer electrolytes while maintaining high ionic conductivities, block copolymer (BCP) electrolytes, containing well-defined conducting pathways and a sturdy supporting matrix, have been proposed. These BCP electrolytes typically are based on the ion-complexation (salt-doping) behavior of ion-conducting domain and the inherent nanoscale phase separation in BCPs. However, the complexation of salts with the solvating blocks of the BCPs can change the properties of the individual polymer domains and the overall copolymer morphology, thus impacting the ionic conductivity and mechanical strength of the nanostructured BCP electrolytes.

BCPs comprise chemically dissimilar polymer segments or blocks that are covalently bound. BCPs provide the opportunity to design materials with attractive transport and mechanical properties based on their ability to self-assemble into periodic structures with domain spacings on the order of 10 nm. Ion solvating and ion transport properties of homopolymer electrolyte systems are important factors in the design of BCP electrolytes. Polymers with sequential polar groups, such as —O—, ═O, —S—, —N—, —P—, C═O, and C═N, may dissolve lithium salts, such as LiPF₆, LiBF₄, LiCF₃SO₃, or LiClO₄, and form polymer-salt complexes. Further, to facilitate the dissociation of inorganic salts in polymer hosts, the lattice energy of the salt should be relatively low and the dielectric constant of the host polymer should be relatively high. Poly(ethylene oxide) (PEO) and poly(propylene oxide) (PPO) are examples of two homopolymers commonly combined with lithium salts for use in dry polymer electrolyte systems.

In recent years, polystyrene-poly(ethylene oxide) (PS-PEO) block polymers have become the most prevalent candidates for BCP electrolytes due to their appealing performance in the batteries. PS-PEO systems can achieve the ionic conductivity on the order of 10⁻³ S/cm at 90° C., and reach a shear modulus on the order of 10⁸ Pa at 90° C. Also, PS-PEO electrolyte cells show a good cycle life with retention of 80% of their initial capacity after 300 cycles at 90° C. and an electrochemical stability window up to 3.7V. However, low room temperature conductivity resulting from the crystallization of the PEO block has limited the application of PS-PEO electrolytes. In other words, PEO is largely crystalline at room temperature and this crystalline structure generally restricts chain mobility, reducing conductivity. Operating PEO electrolytes at high temperature (i.e., above the polymer's melting point) solves the conductivity problem by increasing chain mobility and hence improving ionic conductivity. However, the increased conductivity comes at a cost in terms of deterioration of the material's mechanical properties. At higher temperatures, the polymer no longer behaves as a solid. The operating temperature of PEO-based batteries is typically 80° C. or higher, which makes PEO-based lithium batteries prohibitive for use in electric vehicles and other devices.

There is a need for a block co-polymer that retains the benefits of solid electrolytes, such as PEO-based electrolytes, without the temperature limitations associated with such electrolytes.

### SUMMARY OF THE DISCLOSURE

A solid electrolyte for a solid-state battery or power cell includes poly(propylene oxide) (PPO) as an ionic conductive polymer block. The PPO is an atactic asymmetric monomer. An atactic monomer has substantially no racemo diads, triads or other higher-order substituents. The random placement of the substituents along the polymer chain yields a polymer with a low degree of crystallinity, especially at temperatures below 80° C., thereby preserving good ionic conductivity at lower temperatures than previous solid electrolytes. In one embodiment, the ionic conductivity is at least 10⁻³ S/cm at 80° C. In one embodiment, the atactic PPO has a crystallinity of 15% or less.

The present disclosure provides an electrolyte material comprising at least one linear block copolymer that includes a first polymer block covalently bonded to a second polymer block different from the first polymer block. The first polymer block is an ionically-conductive atactic poly(propylene oxide) block. The ionically-conductive atactic poly(propylene oxide) block is combined with a salt to provide an ionically-conductive domain configured to provide pathways for ion conduction through the electrolyte material. The second polymer block is a structural polymer block configured to provide a structural domain for the electrolyte material.

### DESCRIPTION OF THE DRAWING

FIG. 1 is a structural diagram of the atactic amorphous includes poly(propylene oxide) (PPO) used in the block polymer electrolyte for a solid-state lithium-ion battery according to the present disclosure.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains

Poly(propylene oxide) (PPO) can be prepared with different tacticities—atactic which is substantially amorphous or less than 30% crystalline; syndiotactic which is semi-crystalline, usually in the range of 30-60% crystallinity; and isotactic which 60-80% crystalline. PPO can be prepared at different tactiticies depending on the coordination catalyst used to polymerize the base material. In one embodiment, atactic PPO can be synthesized from propylene oxide (Merck) with a catalyst prepared from diethylzinc [Schering AG, Berlin; 20% (w/w) in toluene] and triphenyltin hydroxide (M &T, Vlissingen, The Netherlands). The PPO is thus less than 30% crystalline. In a more preferred embodiment, the PPO is prepared to a crystallinity of 15% or less.

PPO can be incorporated into a block polymer electrolyte in which an ionic-conducting PPO block is combined with a structural polymer block, such as a polystyrene (PS) block. The two blocks of the di-block polymer electrode are covalently bonded. In addition or alternatively, the structural polymer block can be or include an isotactic polypropylene.

In order to provide pathways through the electrolyte for ion conduction, the PPO is combined with a salt, or more particularly is used as a solvent for a salt. PPO is particularly suitable for dissolving alkali metal salts, such as a lithium salt. In specific embodiments, the lithium salt can be LiPF₆, LiBF₄, LiCF₃SO₃, LiF₃Si or LiClO₄, provided in known concentrations for the particular salt. In another embodiment, the lithium salt is lithium bis(trifluoromethane-sulfonyl)imide (LiC₂F₆NO₄S₂). The resulting atactic PPO-salt complex is amorphous and has an ionic conductivity, a, comparable to PEO complexes.

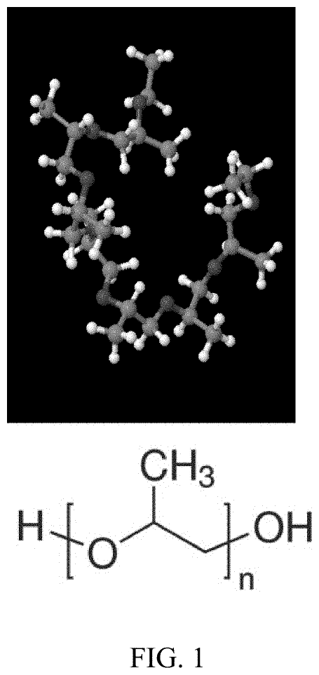

PS-block-PPO block copolymers can be synthesized by sequential anionic polymerization of styrene followed by propylene oxide, using methods described in Anionic Polymerization: High Vacuum Techniques, Hadjichristidis, N.; Iatrou, H.; Pispas, S.; Pitsikalis, M., Journal of Polymer Science, Part A: Polymer Chemistry, Vol. 38, pp. 3211-3234 (2000), the entire disclosure of which is incorporated herein by reference. In order to achieve an atactic PPO, the polymerization proceeds with the catalysts noted above. The amorphous structure of the atactic PPO is illustrated in FIG. 1. The polymer electrolytes can be prepared by mixing the copolymers with a suitable salt, such as the lithium salts identified above, using the techniques described in Effect of Molecular Weight and Salt Concentration on Conductivity of Block Copolymer Electrolytes, Panday, A.; Mulli,n S.; Gomez, E.; Wanakule, N.; Chen, V.; Hexemer, A; Pople, J; Balsara, N; Macromolecules, Vol. 42, pp. 4632-4637 (2009), the entire disclosure of which is incorporated herein by reference, particularly the method steps described in the “Experimental Section” at pp. 4633-4634. The solvent is removed, such as by freeze-drying or evaporation, to yield a dry polymeric material that can be molded or otherwise processed into a film for use as an electrolyte in a lithium-ion battery. Alternatively, the polymer/salt solution may be cast (e.g. spin cast, solution cast, etc.) or printed (i.e. screen printed, ink-jet printed, etc.) or otherwise deposited to form a film. According to certain embodiments, the desired domain structure and morphology naturally may arise upon removal of solvent. Alternatively, the desired domain structure and morphology may arise soon after slight activation of the material such as by heating of the dry polymer material.

The prepared di-block polymer electrolyte can be integrated into a solid-state battery in a known manner between the cathode and anode of the battery and/or within a separator between the cathode and anode. The block electrolyte disclosed herein can be prepared as a thin film for use in thin film lithium-ion batteries in a conventional manner. For instance, the present block polymer electrolyte can be provided as a thin film between a copper foil anode and an aluminum anode. A conventional polypropylene (PP) or polyethylene (PE) porous membrane separator may be provided between the electrodes.

The amorphous atactic PPO-based block polymer electrolyte provides ionic conductivity comparable to other block polymer electrolytes, but exceeds the ionic conductivity of these other electrolytes at lower temperatures, such as at temperatures less than 80° C. In one embodiment, the PPO-based block polymer has an ionic conductivity of at least 10⁻³ S/cm at 80° C. The amorphous nature of the block polymer electrolyte improves electrical isolation between electrodes. The use of the block polymer provides an inherent safety advantage over prior liquid electrolytes. In certain embodiments, the ion-conducting polymer block of the block copolymer electrolyte can include co-polymers of PPO with the PPO described above, provided the co-polymer has a suitable ion conductivity. The addition of the PPO co-polymer to the existing PPO can tailor the physical and electrochemical properties of the resulting electrolyte, albeit with some likely sacrifice to the ionic conductivity properties at lower temperatures. One suitable co-polymer is polyethylene oxide (PEO).

In another embodiment, the conductive block polymer can include polar monomers in combination with the non-polar PPO monomer. The ratio of nonpolar PPO monomer to polar monomer can be varied to tailor the ability of the ion-conducting polymer block to attract and conduct ions, thereby tuning the conductivity of the ion-conducting polymer block. Suitable polar monomers can include polyvinyl chloride and acrylonitrile.

A lithium-ion battery can be formed using the block copolymer electrolyte described above between an anode and a cathode. The anode and cathode can be of conventional construction, as described above. It is contemplated that all of the components of the battery can be configured to form a thin-film battery in a manner known in the art.

The present disclosure should be considered as illustrative and not restrictive in character. It is understood that only certain embodiments have been presented and that all changes, modifications and further applications that come within the spirit of the disclosure are desired to be protected.

What is claimed is:

1. An electrolyte material comprising:
at least one linear block copolymer wherein each of the at least one linear block polymer includes a first polymer block and a second polymer block different from the first polymer block, wherein;
first polymer block and the second polymer block are covalently bonded to one another;
the first polymer block includes ionically-conductive atactic poly(propylene oxide) combined with a salt to provide an ionically-conductive domain configured to provide pathways for ion conduction through the electrolyte material; and
the second polymer block includes a structural polymer configured to provide a structural domain for the electrolyte material.

2. The electrolyte material of claim 1, wherein said second polymer block includes polystyrene.

3. The electrolyte material of claim 1, wherein said second polymer block includes isotactic poly(propylene).

4. The electrolyte material of claim 1, wherein the salt combined with the atactic poly(propylene oxide) is a lithium salt.

5. The electrolyte material of claim 4, wherein the lithium salt is selected from the group including LiC₂F₆NO₄S, LiPF₆, LiBF₄, LiCF₃SO₃, LiF₃Si and LiClO₄.

6. The electrolyte material of claim 1, wherein said first polymer block has an ionic conductivity of at least 10⁻³ S/cm at 80° C.

7. The electrolyte material of claim 1, wherein said atactic poly(propylene oxide) has a crystallinity of less than 15%.

8. A lithium-ion battery comprising:
an anode;
a cathode; and
an electrolyte between said anode and said cathode, said electrolyte including:
at least one linear block copolymer wherein each of the at least one linear block polymer includes a first polymer block and a second polymer block different from the first polymer block, wherein;
first polymer block and the second polymer block are covalently bonded to one another;
the first polymer block includes ionically-conductive atactic poly(propylene oxide) combined with a salt to provide an ionically-conductive domain configured to provide pathways for ion conduction through the electrolyte material; and
the second polymer block includes a structural polymer configured to provide a structural domain for the electrolyte material.

9. The lithium-ion battery of claim 8, wherein said second polymer block includes polystyrene.

10. The lithium-ion battery of claim 8, wherein said second polymer block includes isotactic poly(propylene).

11. The lithium-ion battery of claim 8, wherein the salt combined with the atactic poly(propylene oxide) is a lithium salt.

12. The lithium-ion battery of claim 11, wherein the lithium salt is selected from the group including LiC₂F₆NO₄S₂, LiPF₆, LiBF₄, LiCF₃SO₃, LiF₃Si and LiClO₄.

13. The electrolyte material of claim 8, wherein said first polymer block has an ionic conductivity of at least 10⁻³ S/cm at 80° C.

14. The electrolyte material of claim 8, wherein said atactic poly(propylene oxide) has a crystallinity of less than 15%.
